(19) United States
(12) Patent Application Publication
(10) Pub. No.: US 2013/0142545 A1
(43) Pub. Date: Jun. 6, 2013

(54) IMAGE FORMING APPARATUS

(71) Applicant: CANON KABUSHIKI KAISHA, Tokyo (JP)

(72) Inventor: Toshinori Kimura, Chikusei-shi (JP)

(73) Assignee: CANON KABUSHIKI KAISHA, Tokyo (JP)

(21) Appl. No.: 13/684,970

(22) Filed: Nov. 26, 2012

(30) Foreign Application Priority Data
Dec. 2, 2011 (JP) 2011-264738

(51) Int. Cl. G03G 15/00

(52) U.S. Cl. CPC G03G 15/757
USPC 399/167

(57) ABSTRACT

An image forming apparatus, including: a motor having a winding in which a plurality of coils are connected to one another, the motor configured to rotate an image bearing member by a switchover of a direction of a current flowing through each of the plurality of coils; and a control device configured to switch over the direction of the current flowing through each coil to put a brake on the motor separately from the switchover of the direction of the current flowing through each coil to drive the motor, wherein the control device switches over the direction of the current, according to a brake signal having a period larger than a period of a drive signal for driving the motor, to put a brake on the motor to control a rotation speed of the image bearing member.

### BACKGROUND OF THE INVENTION

1. Field of the Invention

The present invention relates to an image forming apparatus configured to control a rotation speed of an image bearing member.

2. Description of the Related Art

Conventional image forming apparatus include one that employs an electrophotographic process of a type using an intermediate transfer member. In order to form an image by using such an image forming apparatus, a toner image developed on a photosensitive drum is transferred onto an intermediate transfer belt, and after that, the toner image transferred onto the intermediate transfer belt is transferred onto a recording medium. At this time, if a rotation speed of the photosensitive drum changes (varies) over time without remaining constant, unevenness occurs in a developed mass per area of the toner image. Such unevenness in the developed mass per area becomes density unevenness called banding.

Further, the image forming apparatus that can form a full-color image typically includes four photosensitive drums for yellow (Y), magenta (M), cyan (C), and black (K). In general, the four photosensitive drums are disposed side by side along a moving direction of the intermediate transfer belt in descending order of lightness of color, in other words, in the order of the yellow, the magenta, the cyan, and the black. The toner image developed on the photosensitive drum for the yellow is transferred onto the rotating intermediate transfer belt, and then the toner image developed on the photosensitive drum for the magenta is transferred so as to be superimposed on the toner image of the yellow which has been transferred onto the intermediate transfer belt. The toner images are transferred from the photosensitive drums for the cyan and the black in the same manner so as to be superimposed on the toner image on the intermediate transfer belt. At this time, if the photosensitive drums have rotation speeds different from each other, color misregistration occurs in the superimposed toner images.

It is said that the color misregistration occurs due to relatively low-frequency variations in rotation speed of the photosensitive drum, while the banding occurs due to relatively high-frequency variations in rotation speed of the photosensitive drum. Therefore, in order to suppress deterioration of image quality due to the color misregistration or the banding, it is necessary to keep the rotation speeds of the photosensitive drums for the respective colors constant and the same.

It is known that it is preferable that there is a rotation speed difference between the photosensitive drum and the intermediate transfer belt in order to improve efficiency of the transferring of the toner image from the photosensitive drum onto the intermediate transfer belt.

However, if the rotation speed of the photosensitive drum is higher than the rotation speed of the intermediate transfer belt, when the toner image is transferred from the photosensitive drum onto the intermediate transfer belt, the rotation speed of the photosensitive drum is decelerated, while the rotation speed of the intermediate transfer belt is accelerated.

In contrast, if the rotation speed of the photosensitive drum is lower than the rotation speed of the intermediate transfer belt, when the toner image is transferred from the photosensitive drum onto the intermediate transfer belt, the rotation speed of the photosensitive drum is accelerated, while the rotation speed of the intermediate transfer belt is decelerated.

Therefore, if the rotation speed difference is provided between the photosensitive drum and the intermediate transfer belt, the rotation speed of each of the photosensitive drums and the intermediate transfer belt varies due to the rotation speed difference being a disturbance. In particular, the rotation speeds of the photosensitive drum for the yellow and the photosensitive drum for the black, which are disposed on both end portions with respect to the intermediate transfer belt, are likely to vary.

In order to solve the above-mentioned problem, feedback control for detecting the rotation speeds of the photosensitive drum and the intermediate transfer belt to suppress the variations in the rotation speed is used. In the feedback control, the rotation speeds of the photosensitive drum and the intermediate transfer belt are detected. If there are variations in the detected rotation speed, a drive signal for suppressing the variations is input to a motor which drives the photosensitive drum or the intermediate transfer belt. The drive signal can suppress the variations in the rotation speed of the motor.

However, it is difficult for a feedback control system, in which a sufficient control bandwidth is not secured, to cancel a periodic disturbance having a higher bandwidth than the control bandwidth.

Further, the control bandwidth used for a conventional image forming apparatus is not sufficient for a frequency area to be controlled.

FIG. 12 is a diagram illustrating how the rotation speed is controlled in the conventional image forming apparatus. Referring to FIG. 12, the rotation speed which has been accelerated starts to be decelerated at time T_{A}, and again shifts back to acceleration at time T_{B}. Dotted lines 352 and 353 each indicate a tangent line, in other words, an acceleration, of a rotation speed curve 351. The absolute value of a negative acceleration (deceleration) 353 is smaller than the absolute value of a positive acceleration 352. In other words, the deceleration requires more time than the acceleration, and hence there is a limitation on the control bandwidth due to the deceleration.

In order to solve the above-mentioned problem, there is proposed a method of suppressing the color misregistration and the banding by providing a load to the photosensitive drum to control a magnitude of the load so as to cancel speed variations.

However, in a case of using a mechanical mechanism which changes a magnitude of an electric current to control the magnitude of the load, power consumption increases in the motor and the load mechanism. Further, it is not preferable to provide the load even in terms of cost. In addition, a necessary response speed cannot be obtained.

Japanese Patent Application Laid-Open No. H11-027979 discloses a technology for performing speed control by using regenerative braking of the motor, instead of providing the load, to generate a braking torque by the motor. This can solve problems of the power consumption, the cost, and the insufficient control bandwidth.

Specifically, Japanese Patent Application Laid-Open No. H11-027979 proposes a method of improving a speed-reduction following capability by securing a current path in an acceleration direction during an ON period of a pulse width modulation (hereinafter referred to as “PWM”) signal while securing the current path in a direction for decelerating by putting on the regenerative braking during an OFF period of the PWM signal.

However, there is a problem in that the braking torque does not work by braking if the PWM signal has a high frequency with a braking period set short in comparison with a change in phase current.

In contrast, if the frequency of the PWM signal is set low in order to set the braking period long, a control period becomes long, and hence the following problems become more noticeable.

First, the response performance of control is deteriorated as the control period becomes long.

Second, in a brushless DC motor, a torque ripple occurs unless the control period is sufficiently shorter than a period for switching over a phase, and hence smooth driving becomes difficult.

Therefore, if the control period is set long in the structure and configuration disclosed in Japanese Patent Application Laid-Open No. H11-027979, the speed variations may increase instead.

In a case where the speed control is performed by using the braking torque generated by an electric brake, there is a problem in that the braking torque does not work if the braking period is shorter than the time necessary to switch over a direction of a coil current.

### SUMMARY OF THE INVENTION

Therefore, the present invention provides an image forming apparatus which controls a rotation speed of an image bearing member by switching over a direction of a coil current according to a brake signal having a period longer than a period of a drive signal for driving a motor to thereby put a brake on the motor.

An image forming apparatus of the present invention includes: a motor having a winding in which a plurality of coils are connected to one another, the motor configured to rotate an image bearing member by a switchover of a direction of a current flowing through each of the plurality of coils; and a control device configured to switch over the direction of the current of each of the plurality of coils of the motor in order to put a brake on the motor separately from the switchover of the direction of the current flowing through each of the plurality of coils in order to drive the motor, wherein the control device switches over the direction of the current flowing through each of the plurality of coils of the motor, according to a brake signal having a period larger than a period of a drive signal for driving the motor, so as to put a brake on the motor in order to control a rotation speed of the image bearing member.

Further features of the present invention will become apparent from the following description of exemplary embodiments with reference to the attached drawings.

### BRIEF DESCRIPTION OF THE DRAWINGS

FIGS. 1A and 1B are schematic diagrams of an image forming apparatus according to an embodiment of the present invention.

FIG. 2 is a circuit diagram of a three-phase brushless DC motor included in the image forming apparatus according to the embodiment.

FIGS. 3A and 3B are diagrams illustrating variations of signals, voltages, and currents with time in the three-phase brushless DC motor of the image forming apparatus according to the embodiment.

FIGS. 4A, 4B, and 4C are diagrams illustrating a flow of the current in the three-phase brushless DC motor of the image forming apparatus according to the embodiment.

FIG. 5 is a table showing relationships between outputs of magnetic sensors and phases to be excited in the three-phase brushless DC motor of the image forming apparatus according to the embodiment.

FIG. 6 is a perspective view of a rotary encoder mounted on a motor shaft of the three-phase brushless DC motor of the image forming apparatus according to the embodiment.

FIGS. 7A, 7B, 7C, 7D, and 7E are diagrams illustrating variations of the respective signals and rotation speeds with time in a rotation speed control performed by feedback control in the three-phase brushless DC motor of the image forming apparatus according to the embodiment.

FIG. 8 is a schematic diagram of a torque generated by rotation speed control using regenerative braking in the three-phase brushless DC motor of the image forming apparatus according to the embodiment.

FIG. 9 is a block diagram of a rotation speed control system applied to the three-phase brushless DC motor of the image forming apparatus according to the embodiment.

FIG. 10 is a flowchart of the rotation speed control in the three-phase brushless DC motor of the image forming apparatus according to the embodiment.

FIG. 11 is a diagram illustrating a control output value and signals that are obtained by subjecting the control output value to pulse width modulation and frequency modulation in the three-phase brushless DC motor of the image forming apparatus according to the embodiment.

FIG. 12 is a diagram illustrating rotation speed control in a conventional image forming apparatus.

### DESCRIPTION OF THE EMBODIMENTS

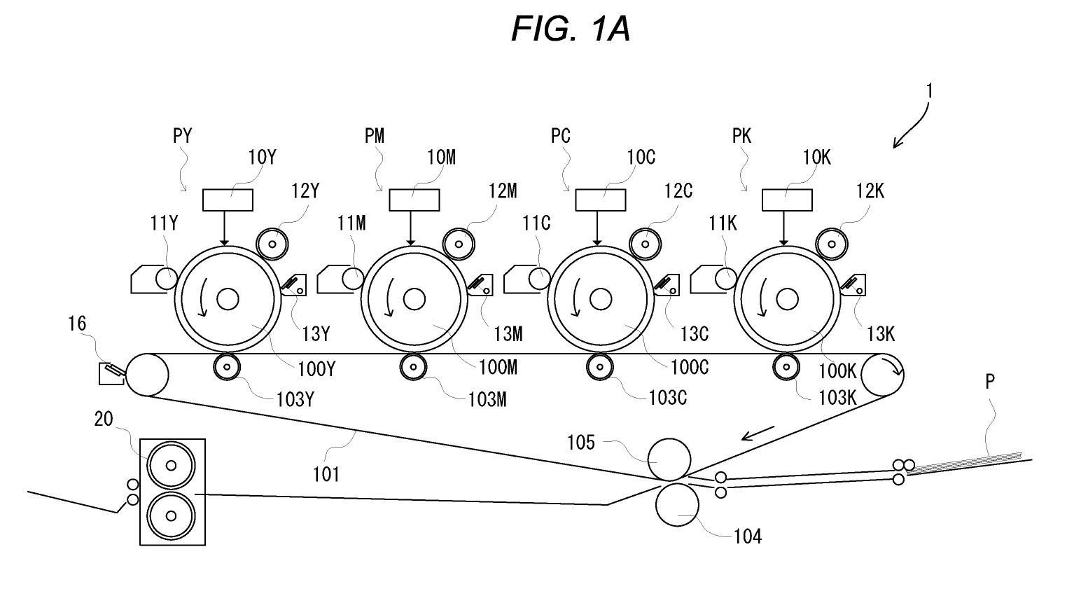

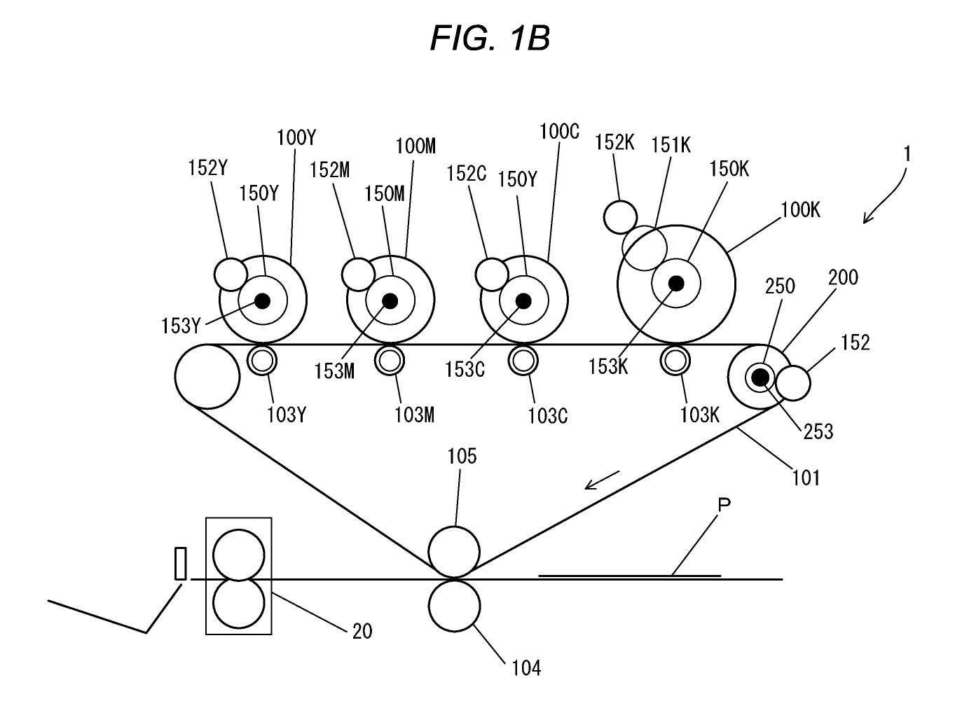

FIGS. 1A and 1B are schematic diagrams illustrating an image forming apparatus 1 according to an embodiment. FIGS. 1A and 1B are an overall schematic diagram of the image forming apparatus 1 and a schematic diagram illustrating a drive system of the image forming apparatus 1, respectively.

As illustrated in FIG. 1A, the image forming apparatus 1 includes four image formation stations PY, PM, PC, and PK for yellow, magenta, cyan, and black, respectively. In FIGS. 1A and 1B, the image formation stations PY, PM, PC and PK for respective colors Y, M, C and K of the image forming apparatus 1 have the same structure except that colors of developers to be used are different from one another, and hence Y, M, C, or K may be omitted in the following description for the sake of simplicity.

In the respective image formation stations P, a photosensitive drum (image bearing member) 100 is uniformly charged by a primary charging device 12. By scanning and exposing a uniformly charged surface of the photosensitive drum 100 with a laser beam emitted from an exposure portion 10, an electrostatic latent image is formed on the photosensitive drum 100. A developing device 11 makes a toner as a developer adhere to the formed electrostatic latent image to develop the electrostatic latent image into a toner image. The toner images of the respective colors which are formed on the respective photosensitive drums 100 are sequentially transferred onto a moving intermediate transfer belt (image bearing member) 101 by primary transfer outer rollers 103 so as to be superimposed on top of each other.

Then, the color toner images formed on the intermediate transfer belt 101 are collectively transferred onto a transferring material P, which has been conveyed, in a secondary transfer nip portion formed by a secondary transfer roller 105 and a secondary transfer outer roller 104, which are opposed to each other. The transferring material P subjected to the collective transferring is conveyed to a fixing device 20 in which the toner images are fixed to the transferring material P. Then, the transferring material P is delivered to outside of the image forming apparatus 1. Thereby, a color image is obtained.

The toner remaining on the photosensitive drum 100 without being transferred onto the intermediate transfer belt 101 is removed by a cleaner 13. In the same manner, the toner remaining on the intermediate transfer belt 101 without being transferred onto the transferring material P is removed by an intermediate transfer belt cleaner 16.

As illustrated in FIG. 1B, a photosensitive drum drive system rotates the photosensitive drums 100 for the yellow, the magenta, and the cyan by transmitting a torque of motors 152 to the photosensitive drums 100 through gears 150. The photosensitive drum drive system rotates the photosensitive drum 100K for the black by transmitting the torque of a motor 152K to the photosensitive drum 100K through gears 151K and 150K. Rotation speed information necessary to perform speed control on the photosensitive drums 100 is acquired by rotary encoders (speed detectors) 153 mounted on shafts of the photosensitive drums 100.

In the same manner, an intermediate transfer belt drive system also rotates an intermediate transfer belt drive roller (rotary member) 200 by transmitting the torque of the motor 152 to the intermediate transfer belt drive roller 200 through a gear 250, which causes the intermediate transfer belt 101 to rotate. The rotation speed information necessary to perform the speed control on the intermediate transfer belt 101 is acquired by a rotary encoder (speed detector) 253 mounted on a shaft of the intermediate transfer belt drive roller 200.

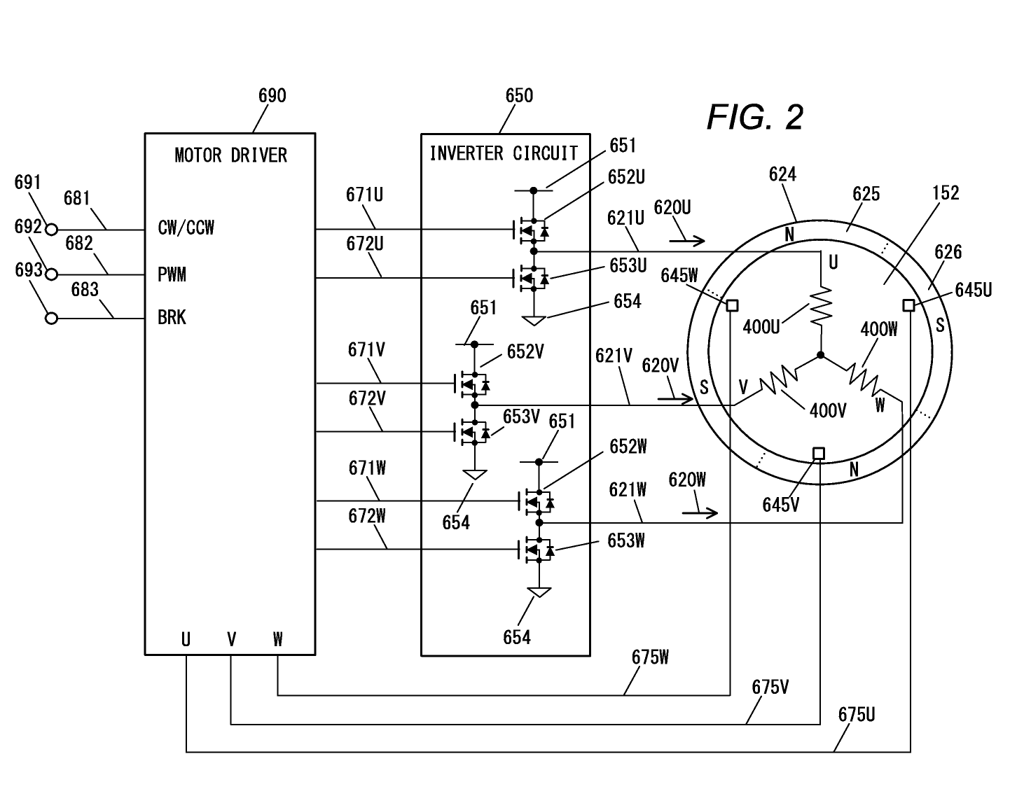

FIG. 2 is a circuit diagram of a three-phase brushless DC motor 152 included in the image forming apparatus 1 according to the embodiment. Suffixes “U”, “V”, and “W” corresponding to a U phase, a V phase, and a W phase, respectively, are added to each of reference numerals indicating some components, and may be omitted for the sake of simplicity.

The three-phase brushless DC motor 152 includes a winding in which three coils 400U, 400V, and 400W are connected to one another by a star connection.

The three-phase brushless DC motor 152 is generally classified into two rotors, in other words, an inner rotor having a rotor in an inside thereof and an outer rotor having a rotor in an outside thereof. In this embodiment, the outer rotor is used.

In the three-phase brushless DC motor 152 serving as the outer rotor, a rotor 624 includes two N-poles 625 and two S-poles 626. Note that, the number of magnetic poles is not limited thereto.

The rotor 624 is coupled to a motor shaft, and is structured to rotate about the shaft.

A magnetic flux density within the rotor 624 is small in a boundary between the N-pole 625 and the S-pole 626 and becomes larger in a portion farther away from the boundary.

The motor generates an attractive force and a repulsive force with respect to the magnetic poles of the rotor by exciting a desired phase.

In this embodiment, when a current flows from the rotor 624 toward a center of the star connection through the coil 400, a magnetic flux occurs from the coil 400 toward the rotor 624 while generating the repulsive force with respect to the N-pole 625 and generating the attractive force with respect to the S-pole 626. In contrast, when the current flows from the center of the star connection toward the rotor 624, the magnetic flux occurs from the rotor 624 toward the coil 400 while generating the attractive force with respect to the N-pole 625 and generating the repulsive force with respect to the S-pole 626.

The above-mentioned attractive force and repulsive force generate a torque to start rotating the rotor 624. The rotation of the rotor 624 is maintained by switching over the phase to be excited according to a magnetic pole position. A magnitude of the torque is expressed by an amount obtained by multiplying a magnitude of a phase current flowing through each phase by a torque constant.

A switchover of the phase to be excited is determined by detecting the magnetic pole position of the rotor 624 by using magnetic sensors 645 provided in proximity to the rotor 624 to thereby determine the phase to be excited and a direction of the current. The magnetic sensor 645 outputs a positive voltage when the magnetic pole of the rotor 624 is an N-pole and outputs a negative voltage when the magnetic pole of the rotor 624 is an S-pole. In this embodiment, a Hall element is used as the magnetic sensor 645, but the present invention is not limited thereto.

In order to switch over the phase to be excited as described above, an inverter circuit 650 is generally used as a circuit configured to adjust the direction and the magnitude of the current caused to flow through each of the coils 400U, 400V, and 400W.

Further, a motor driver 690 is used as a circuit configured to provide the inverter circuit 650 with instructions of a sequence of switching over the phases to be excited and the direction and the magnitude of the current caused to flow through each of the coils 400U, 400V, and 400W based on output voltages 675 from the magnetic sensors 645.

A line 621U electrically connects the coil 400U to a switching element 652U and a switching element 653U. A line 621V electrically connects the coil 400V to a switching element 652V and a switching element 653V. A line 621W electrically connects the coil 400W to a switching element 652W and a switching element 653W.

The motor driver (control device) 690 transmits a drive signal (pulse width modulation signal, hereinafter referred to as “PWM signal”) 671 for driving the three-phase brushless DC motor 152 to the inverter circuit 650. The inverter circuit 650 uses the switching elements 652 to effect conduction or non-conduction between a power supply 651 and the coil 400 based on whether a voltage level of the PWM signal 671 received from the motor driver 690 is High or Low.

In order to switch over the phase to be excited, the motor driver 690 transmits three PWM signals 671U, 671V, and 671W to the inverter circuit 650 based on a PWM signal 682 input to a drive signal terminal 692 of the motor driver 690. The PWM signal 682 is a square-wave signal subjected to pulse width modulation, and is assumed here as a signal having a frequency of 25 kHz. Therefore, based on the PWM signal 682, the motor driver 690 inputs the PWM signal 671 to the switching elements 652 for the phase to be excited. The PWM signal 671 chops the current of the power supply 651 to adjust an average value of the voltage applied to the coil 400 so as to adjust the magnitude of a phase current (coil current) 620 flowing through the coil 400.

Further, in order to switch over the phase to be excited, the motor driver 690 transmits a phase switchover signal 672 to the inverter circuit 650 based on the output from the magnetic sensor 645. The inverter circuit 650 uses the switching elements 653 to effect conduction or non-conduction between the coils 400 and a ground (hereinafter referred to as “GND”) 654 based on whether the voltage level of the phase switchover signal 672 is High or Low.

Next, a sequence of rotating the rotor 624 will be described in detail.

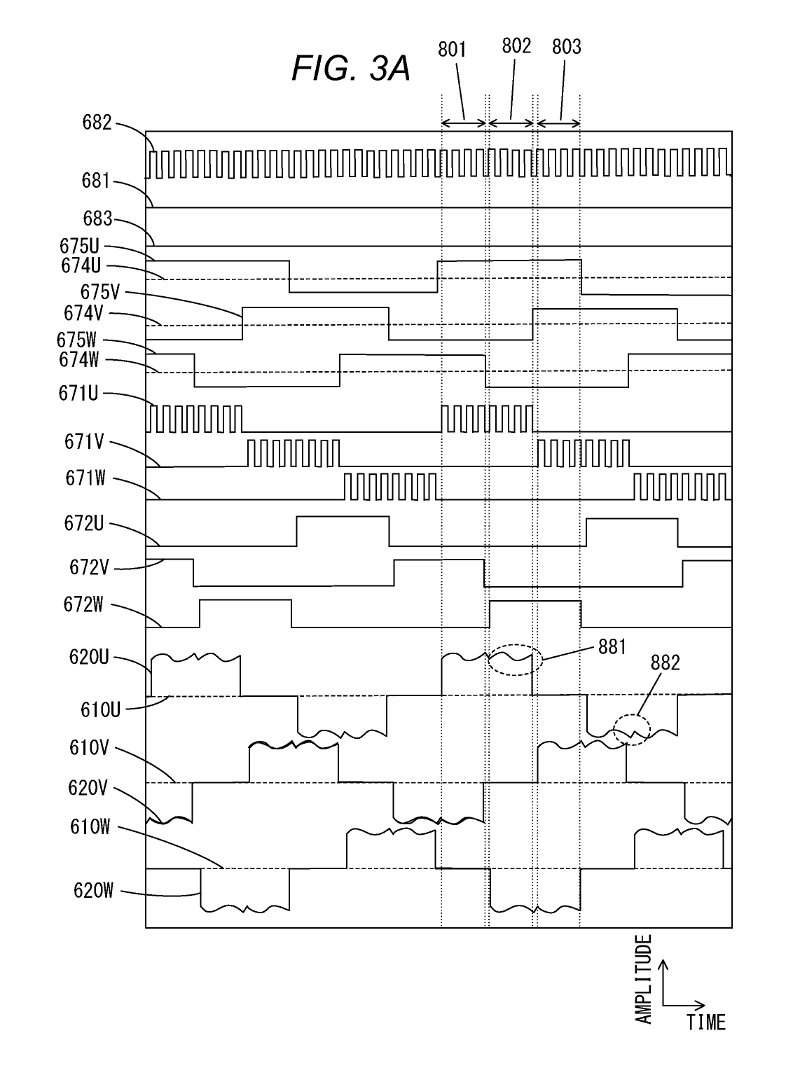

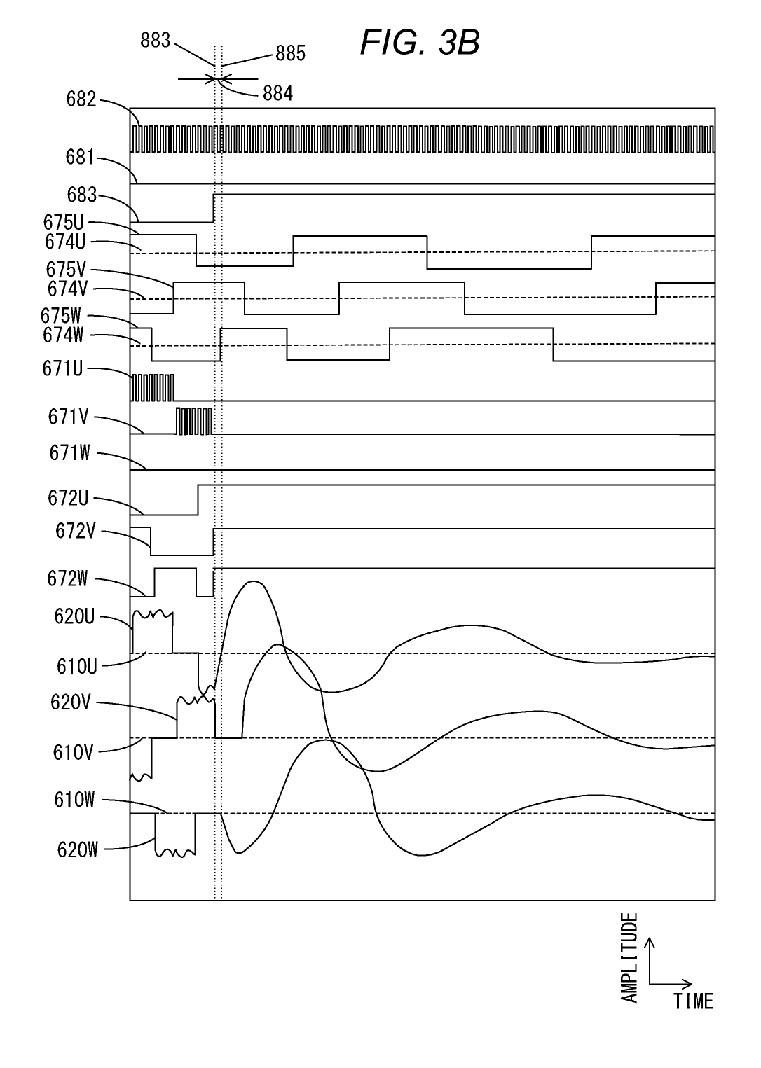

FIG. 3A illustrates variations of respective signals, respective voltages, and respective currents with time in the three-phase brushless DC motor 152 of the image forming apparatus 1 according to the embodiment.

First, a rotational direction switchover signal 681 is input to a rotational direction switchover terminal 691 (FIG. 2) of the motor driver 690, and the rotational direction of the rotor 624 is determined based on whether the voltage level of the rotational direction switchover signal 681 is High or Low. In this embodiment, it is assumed that the voltage level of the rotational direction switchover signal 681 is Low and that the rotor 624 rotates in a clockwise direction (hereinafter referred to as “CW direction”) as viewed from a load side (from the back side of the page of FIG. 2).

Further, a brake signal (hereinafter referred to as “BRK signal”) 683 is input to a brake signal terminal (hereinafter referred to as “BRK signal terminal”) 693 (FIG. 2) of the motor driver 690, and the brake of the rotor 624 is turned ON or OFF based on whether the voltage level of the BRK signal 683 is High or Low. In this embodiment, the brake is turned OFF when the voltage level of the BRK signal 683 is Low.

Then, as described above, the rotor 624 rotates by the PWM signal 682 input to the drive signal terminal 692 (FIG. 2) of the motor driver 690. Note that, in this embodiment, the PWM signal 682 has a frequency of 25 kHz.

Next, a sequence of switching over excitation of the respective phases in respective segments 801, 802, and 803 of FIG. 3A will be described.

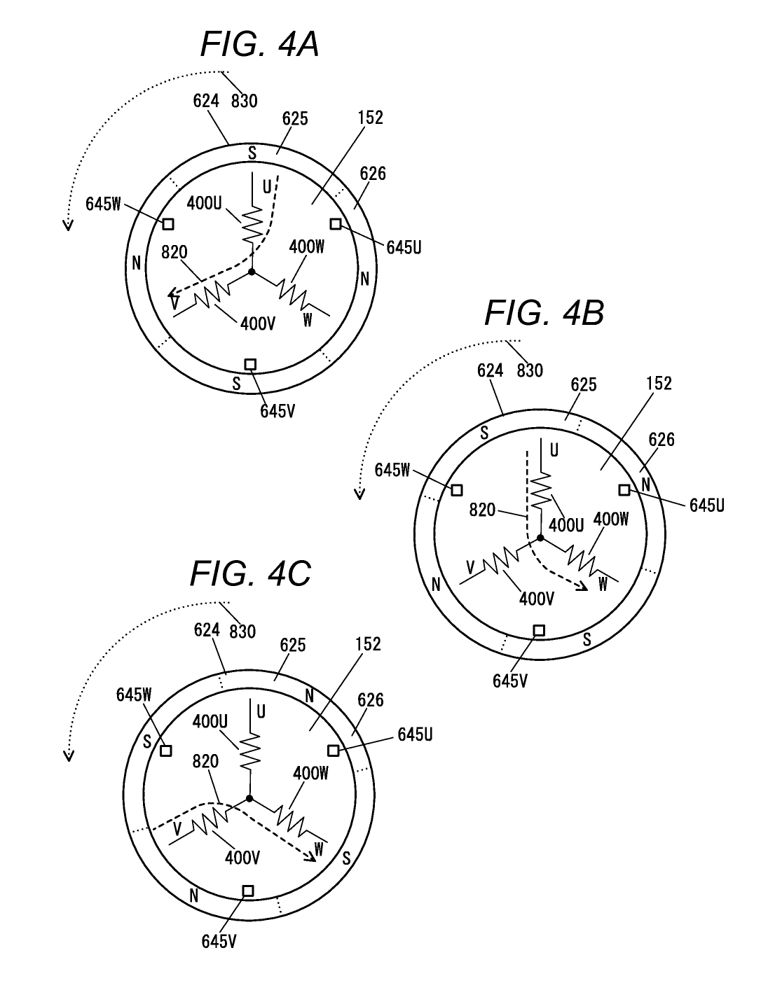

FIG. 4A illustrates a position of the rotor 624 in the segment 801.

As described above, a rotational direction 830 of the rotor 624 is the CW direction as viewed from the load side. In the arrangement of the rotor 624 illustrated in FIG. 4A, the magnetic sensors 645U, 645V, and 645W are adjacent to the N-pole, the S-pole, and the N-pole, respectively. Therefore, as illustrated in the segment 801 of FIG. 3A, the magnetic sensors 645U, 645V, and 645W output a predetermined positive voltage 675U, a predetermined negative voltage 675V, and a predetermined positive voltage 675W, respectively, with reference to 0-V lines 674U, 674V, and 674W of output voltages.

In this state, it suffices that the U phase and the V phase are excited (hereinafter referred to as “UV phases are excited”; the current is assumed to flow in the order of the stated phases). For that reason, the PWM signal 682 is input to the PWM signal 671U, a voltage signal having a Low level is input to the PWM signals 671V and 671W, a voltage of a High level is input to the phase switchover signal 672V, and a voltage of a Low level is input to the phase switchover signals 672U and 672W. Accordingly, in the arrangement of the rotor 624 of FIG. 4A, the UV phases are excited, and a positive U-phase current 620U and a negative V-phase current 620V flow with reference to lines 610U and 610V of the output current being zero, to thereby generate a torque and rotate the rotor 624.

FIG. 4B illustrates a position of the rotor 624 in the segment 802.

In the arrangement of the rotor 624 illustrated in FIG. 4B, the magnetic sensors 645U, 645V, and 645W are adjacent to the N-pole, the S-pole, and the S-pole, respectively. Therefore, as illustrated in the segment 802 of FIG. 3A, the magnetic sensors 645U, 645V, and 645W output a predetermined positive voltage 675U, a predetermined negative voltage 675V, and a predetermined negative voltage 675W, respectively, with reference to the 0-V lines 674U, 674V, and 674W of output voltages.

In this state, it suffices that UW phases are excited. Therefore, in the same manner as in the segment 801, the PWM signal 682 is input to the PWM signal 671U, and the voltage signal having a Low level is input to the PWM signals 671V and 671W. Meanwhile, with regard to the phase switchover signal 672, in order to switch over from the V phase to the W phase, the voltage of a High level is input to the phase switchover signal 672W, and the voltage of a Low level is input to the phase switchover signals 672U and 672V. Accordingly, the UW phases are excited, and a positive U-phase current 620U and a negative W-phase current 620W flow with reference to lines 610U and 610W of the output current being zero, to thereby generate a torque and rotate the rotor 624.

FIG. 4C illustrates a position of the rotor 624 in the segment 803.

In the arrangement of the rotor 624 illustrated in FIG. 4C, the magnetic sensors 645U, 645V, and 645W are adjacent to the N-pole, the N-pole, and the S-pole, respectively. Therefore, as illustrated in the segment 803 of FIG. 3A, the magnetic sensors 645U, 645V, and 645W output a predetermined positive voltage 675U, a predetermined positive voltage 675V, and a predetermined negative voltage 675W, respectively, with reference to the 0-V lines 674U, 674V, and 674W of output voltages.

In this state, it suffices that VW phases are excited. Therefore, with regard to the PWM signal 671, in order to switch over from the U phase to the V phase, the PWM signal 682 is input to the PWM signal 671V, and the voltage signal having a Low level is input to the PWM signals 671U and 671W. Further, with regard to the phase switchover signal 672, the voltage of a High level is input to the phase switchover signal 672W, and the voltage of a Low level is input to the phase switchover signal 672U and the phase switchover signal 672V. Accordingly, the VW phases are excited, and a positive V-phase current 620V and a negative W-phase current 620W flow with reference to lines 610V and 610W of the output current being zero, to thereby generate a torque and rotate the rotor 624.

By switching over the phase to be excited by the above-mentioned sequence, it is possible to maintain the rotation of the rotor 624.

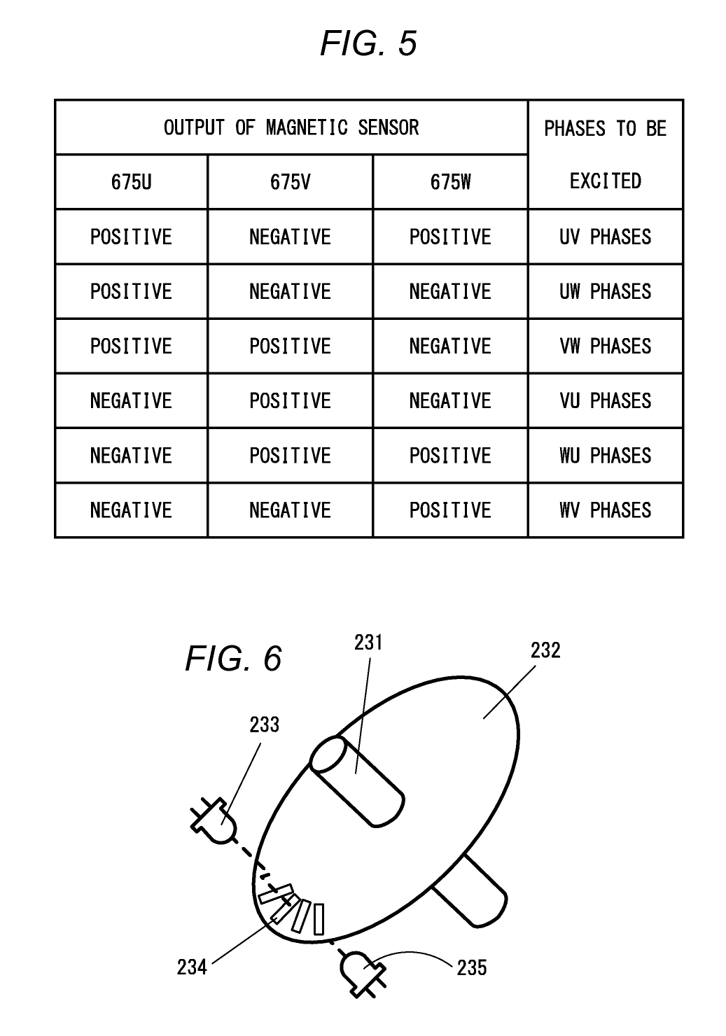

Note that, FIG. 5 shows a list of the phases to be excited with respect to the output voltages 675 of the magnetic sensors 645 in order to maintain a CW-direction rotation of the rotor 624.

As illustrated in FIG. 3A, there is a non-excitation segment in which no phases are excited between the segments 801 and 802 and between the segments 802 and 803. The non-excitation segment is provided in order to prevent the switching elements 652 and 653 (FIG. 2) from being simultaneously brought into a conducting state in which a penetrating current flows from the power supply 651 to the GND 654. Therefore, discontinuous points 882 occur in a phase current 620, but are temporally short compared to the change of the phase current 620, which does not become a problem in terms of operation.

Fluctuations 881 of the phase current 620 are caused by an electromotive voltage generated by electromagnetic induction when the magnetic flux passing through the coils 400 is changed by the rotation of the rotor 624.

Next, the rotation speed control with the three-phase brushless DC motor 152 according to the embodiment will be described.

FIG. 6 is a perspective view of a rotary encoder 231 mounted on the motor shaft of the three-phase brushless DC motor 152.

In this embodiment, a rotation speed of the motor 152 is detected and obtained by the rotary encoder 231. In the rotary encoder 231, slits 234 are formed in a disc 232 at regular intervals, and a light-emitting element 233 and a light-receiving element 235 are arranged so as to sandwich the disc 232 perpendicularly to the surface of the disc 232.

Based on whether or not light emitted from the light-emitting element 233 is received by the light-receiving element 235 through the slits 234, the light-receiving element 235 outputs the voltage of a High level or a Low level.

The rotation of the motor 152 causes the voltage level output by the light-receiving element 235 to change periodically, and hence the output from the rotary encoder 231 becomes a pulse shape, and the rotation speed of the motor 152 can be detected from the period thereof or the frequency thereof.

In this embodiment, a target rotation speed of 3 revolutions per second (rps) is set for the rotation speed control, and a deviation between the target rotation speed and the actual rotation speed of the motor 152 is input to a controller.

Note that, in this embodiment, a generally-used PID controller is used as the controller. The PID controller is constituted of a proportional operation (Proportional), an integral operation (Integral), and a derivative operation (Derivative), and outputs a sum of the respective values output therefrom. In the PID controller, the proportional operation outputs a value obtained by multiplying the deviation by a predetermined value (P gain), the integral operation outputs a value obtained by multiplying a value obtained by integrating the deviation by a predetermined value (I gain), and the derivative operation outputs a value obtained by multiplying a change amount in speed by a predetermined value (D gain).

Then, the output from the PID controller corresponding to the deviation between the target rotation speed and the actual rotation speed of the motor 152 is converted into the PWM signal 682. The PWM signal 682 is input to the motor driver 690 as a drive signal for driving the motor 152. In this embodiment, the frequency of the PWM signal 682 is set to 25 kHz.

The torque that contributes to the rotation of the motor 152 changes according to the PWM signal 682, which changes the rotation speed of the motor 152. Then, the actual rotation speed of the motor 152 is obtained from the rotary encoder 231. The deviation between the actual rotation speed and the target rotation speed is obtained, and the obtained deviation is input to the PID controller. In this embodiment, such an operation is repeated every 10 ms.

In other words, in this embodiment, the above-mentioned feedback control is performed.

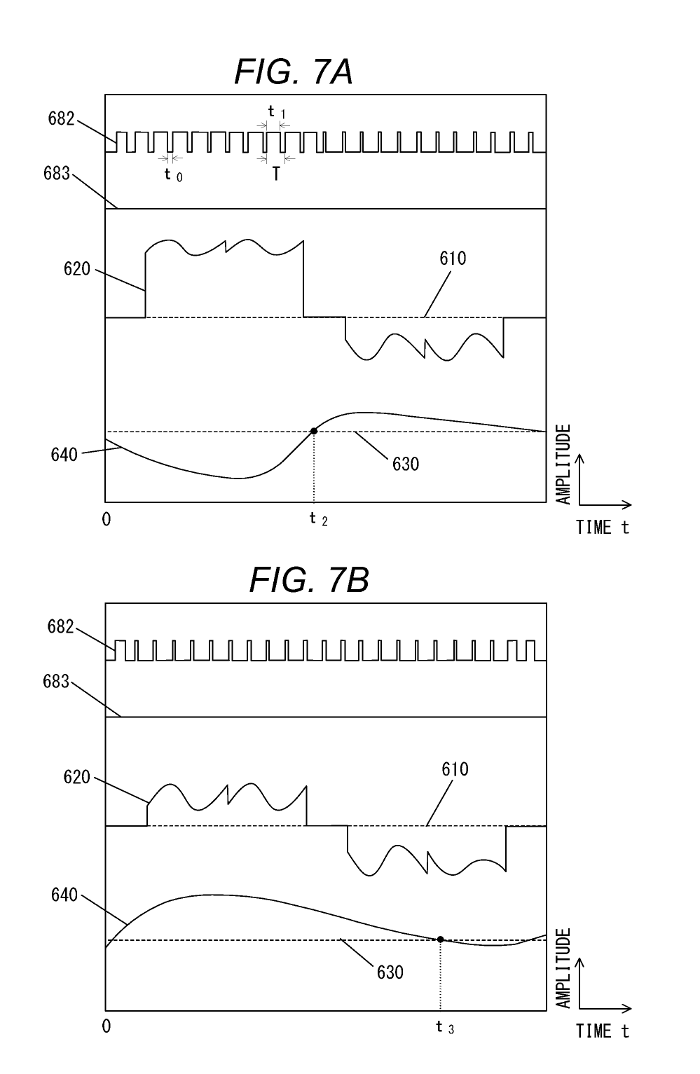

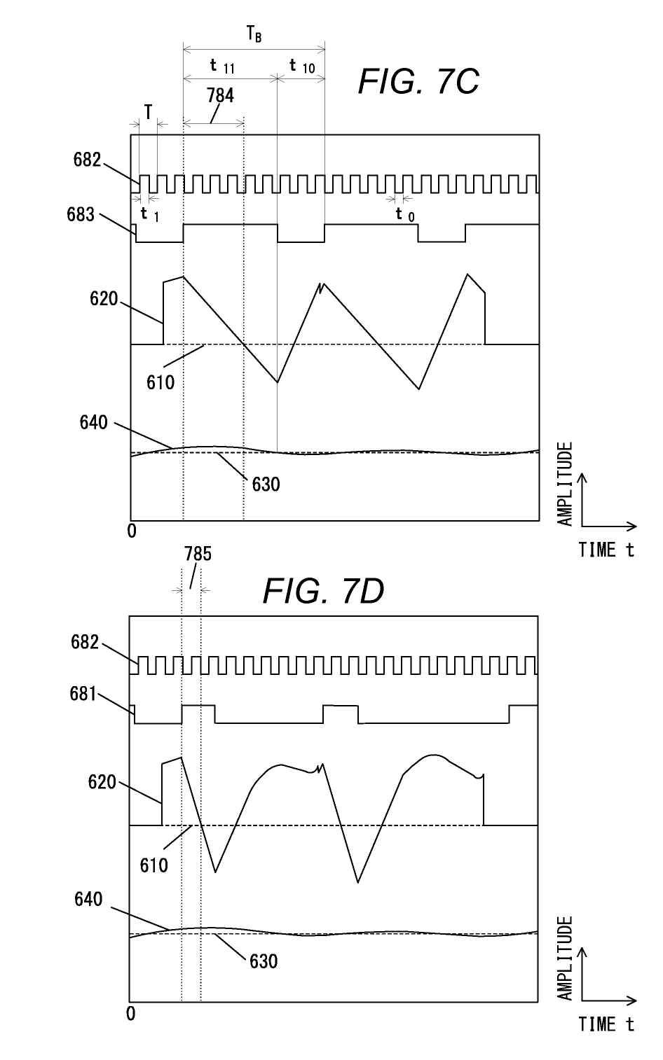

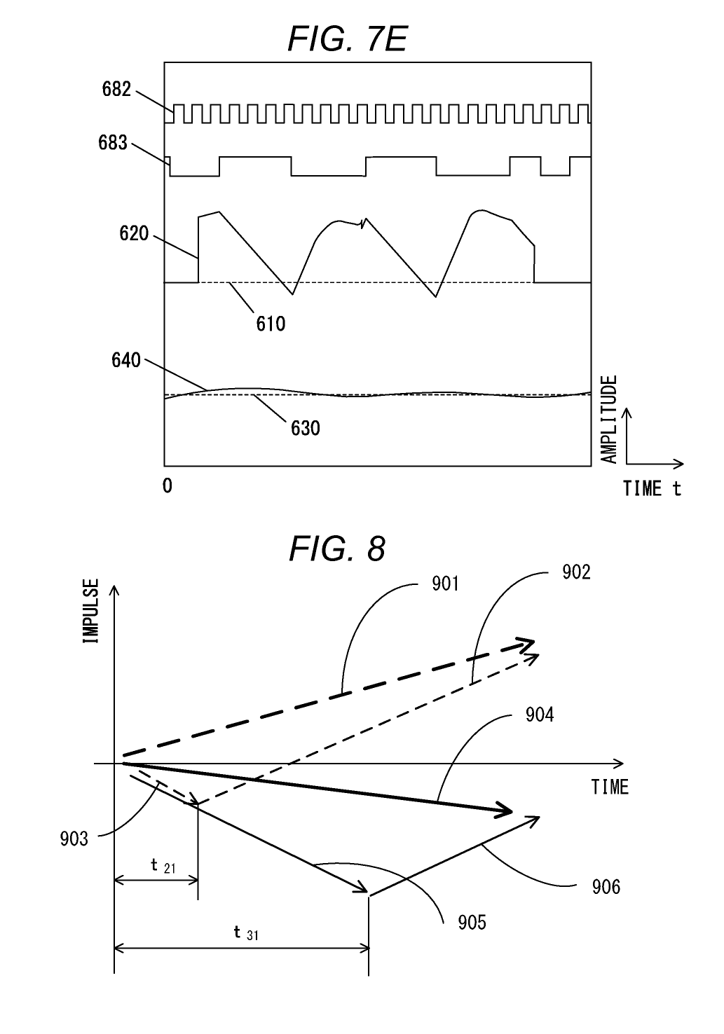

FIGS. 7A, 7B, 7C, 7D, and 7E illustrate variations of the respective signals and rotation speeds with time in the rotation speed control performed by the feedback control in the three-phase brushless DC motor 152.

FIG. 7A illustrates the variations of the respective signals and the rotation speed with time in the rotation speed control when a disturbance is input in a deceleration direction of the motor 152.

When a rotation speed 640 of the motor 152 is decelerated due to the disturbance, a deviation occurs between the actual rotation speed 640 and the target rotation speed 630, and a duty cycle of the PWM signal 682 therefore becomes large, which accelerates the motor 152. In this case, the duty cycle of the PWM signal 682 is expressed by a ratio of a High-level period t₁ to a period T of the PWM signal 682, in other words, t₁/T×100(%). That is, the duty cycle becoming larger means that the High-level period t₁ of the PWM signal 682 becomes longer with reference to the period T of the PWM signal 682. Note that, in this case, the duty cycle is set to 80%.

A relationship between a frequency F_{D} of the PWM signal 682 and the period T is expressed by the following Expression 1.

F_{D}=1/T=1/(t₁+t₀) (Expression 1)

In Expression 1, t₀ represents a period of a Low level of a PWM signal. When the frequency F_{D} of the PWM signal is 25 kHz, the period T of the PWM signal is 40 microseconds. When the duty cycle is 80%, the High-level period t₁ of the PWM signal is 32 microseconds.

After the duty cycle of the PWM signal 682 is set to 80%, when the rotation speed 640 becomes higher than the target rotation speed 630, the duty cycle of the PWM signal 682 is reduced in turn, to thereby decelerate the rotation speed 640.

By repeating the above-mentioned operation, the rotation speed 640 is stabilized at the target rotation speed 630 at last, and the duty cycle of the PWM signal 682 is set to 50% being the same as the duty cycle in a normal time. The High-level period t₁ of the PWM signal obtained when the duty cycle is 50% is 20 microseconds.

FIG. 7B illustrates the variations of the respective signals and the rotation speed with time in the rotation speed control when a disturbance is input in an acceleration direction of the motor 152.

When the rotation speed 640 of the motor 152 is accelerated due to the disturbance, the rotation speed 640 is decelerated by reducing the duty cycle of the PWM signal 682. Note that, it is assumed in this case that the duty cycle is set to 20%. When the duty cycle is 20%, the High-level period t₁ of the PWM signal is 8 microseconds.

After that, when the rotation speed 640 becomes lower than the target rotation speed 630, the duty cycle of the PWM signal 682 is increased in turn, to thereby accelerate the rotation speed 640.

By repeating the above-mentioned operation, the rotation speed 640 is stabilized at the target rotation speed 630 at last, and the duty cycle of the PWM signal 682 is set to 50% being the same as the duty cycle in the normal time.

Referring to FIG. 7A, the rotation speed 640 is accelerated after the disturbance is input at t=0, and the rotation speed 640 temporarily reaches the target rotation speed 630 at time t₂. On the other hand, referring to FIG. 7B, the rotation speed 640 is decelerated after the disturbance is input at t=0, and the rotation speed 640 temporarily reaches the target rotation speed 630 at time t₃. Further, as described above, the duty cycle is 80% at the time of the acceleration in FIG. 7A, while the duty cycle is 20% at the time of the deceleration in FIG. 7B. In other words, irrespective of the same difference from 50% in the normal time of the respective duty cycles (in other words, 80−50=50−20=(difference of 30%)), the time t₂ and the time t₃ greatly differ from each other. In other words, a slope of the speed change at the time of the acceleration for reaching the target rotation speed 630 illustrated in FIG. 7A and a slope of the speed change at the time of the deceleration for reaching the target rotation speed 630 illustrated in FIG. 7B, in other words, the respective magnitudes of accelerations greatly differ from each other.

This is because a friction force for hindering the rotation of the motor 152 is small. The friction force is generated in a bearing portion of the motor 152. Further, in the image forming apparatus 1, the friction force is generated also by, for example, contact with the cleaner 13 of the photosensitive drum 100. Due to the generation of the friction force, the rotation speed 640 is lowered when the duty cycle is reduced.

Therefore, if the friction force is small, the acceleration at the time of the deceleration becomes small, with the result that more time is required to decelerate the rotation speed 640. In other words, it is difficult to decelerate an abrupt change in the acceleration of the rotation speed 640 caused by the disturbance by using the friction force.

In general, it is well-known that there are braking methods such as regenerative braking and reverse current braking (plugging) for rapidly stopping a rotor of a motor.

In the following, the regenerative braking being one of the braking methods will be described.

When voltage signals having a High level are input to the phase switchover signals 672U, 672V, and 672W and voltage signals having a Low level are input to the PWM signals 671U, 671V, and 671W, the switching elements 653U, 653V, and 653W (FIG. 2) are brought into a conduction state.

A timing at which the above-mentioned operation is performed is hereinafter referred to as “time at which the regenerative braking is put on”.

In this case, as illustrated in FIG. 2, the power supply 651 is disconnected by the switching elements 652 so that a current does not flow from the power supply 651.

When the motor 152 is rotating, the electromotive voltage is generated in the coils 400 by electromagnetic induction caused by the magnetic pole of the rotor 624. The electromotive voltage is called “counter-electromotive voltage (counter-electromotive force)”, and works so as to cause the current to flow in a reverse direction to the phase current 620 that contributes to the rotation of the rotor 624. Therefore, the conduction between the power supply 651 and the coils 400 is disconnected, and hence the phase current 620 becomes smaller and smaller, which finally causes the counter-electromotive voltage to flow the current through the coils 400 in the reverse direction to the direction in which the current flows before the regenerative braking is put on. The current flowing in the reverse direction also causes the direction of the magnetic flux generated by the coils 400 to become reverse to the direction of the magnetic flux before the regenerative braking is put on.

Therefore, by putting the regenerative braking on the rotor 624 in which an accelerating torque for accelerating the rotation has been generated, a braking torque for suppressing the rotation of the rotor 624, which is reverse to the accelerating torque, is generated to rapidly decelerate and stop the rotor 624.

FIG. 3B illustrates the variations of the respective signals, respective voltages, and respective currents with time, which are obtained in putting on the regenerative braking.

Referring to FIG. 3B, at a timing 883, the voltage of the BRK signal 683 shifts from Low to High, which indicates that the regenerative braking starts to be put on. It is indicated that, when the regenerative braking is put on, the phase current 620 changes so as to generate the braking torque, and a waveform of the phase current 620 appears to be a sine wave with the phases of the respective phase currents 620 deviated from one another by 120°. This is because the counter-electromotive voltage changes according to the change of the magnetic flux caused by the rotation of the rotor 624, and the rotation speed is lowered, while the phase current 620 flowing through the phase becomes small.

Therefore, in the case of putting on the regenerative braking in order to decelerate the rotation speed of the rotor 624, the BRK signal 683 having a voltage level of High is input to the BRK signal terminal 693 (FIG. 2) of the motor driver 690, to thereby decelerate the rotor 624 while indicating the above-mentioned behavior.

However, looking at FIG. 3B carefully, immediately after the timing 883 at which the regenerative braking starts to be put on, the phase current 620 of each phase flows by inertia in the same direction as before the timing 883. Therefore, the braking torque is not generated yet immediately after the timing 883. The braking torque is generated after a timing 885 at which the current starts to flow in a direction reverse to the direction of the phase current 620 flowed by exciting the corresponding phase in order to generate the accelerating torque.

Therefore, a delay time 884 exists between the timing 883 at which the operation is shifted to the regenerative braking operation and the timing 885 at which the braking torque is generated. The delay time 884 varies depending on the magnitude of the phase current 620 obtained when the operation is shifted to the regenerative braking operation (in other words, at the timing 883) or a resistance or an inductance of the coil 400. For that reason, in order to generate the braking torque, it is necessary to input the BRK signal 683 having a voltage level of High to the BRK signal terminal 693 for a time equal to or longer than a predetermined time.

It is preferable that the predetermined time is longer than the delay time 884. The delay time 884 is a time period between a time at which the BRK signal 683 becomes ON state (a time at which the voltage level of the BRK signal 683 becomes High) and a time at which the current starts to flow through the coil 400 in the direction reverse to the direction of the phase current 620. In other words, the delay time 884 is a time period necessary to switch over the direction of the phase current (coil current).

In consideration of the above-mentioned fact, in this embodiment, the rotation speed control of the three-phase brushless DC motor 152 is performed by the regenerative braking. By using the regenerative braking to increase the acceleration at the time of the deceleration, it is possible to raise a control bandwidth.

In the case of performing the rotation speed control of the motor 152 using the regenerative braking, it is preferable that a signal having a phase reverse to a phase of the PWM signal 682 is output to the BRK signal 683 and the frequencies of the PWM signal 682 and the BRK signal 683 are lowered. The frequencies of the PWM signal 682 and the BRK signal 683 are lowered because, as described above, it is necessary to input the BRK signal 683 having a voltage level of High to the BRK signal terminal 693 for the time equal to or longer than the predetermined time.

However, there is a fear that, if a control period of the PWM signal 682 is lowered in consideration of the delay time 884, the control bandwidth may become narrow to fail in the rotation speed control.

In order to solve such a problem, the frequency of the PWM signal 682 input to the drive signal terminal 692 is kept at 25 kHz without matching up with the frequency of the BRK signal 683, and the duty cycle of the PWM signal 682 is set at a constant value. Further, the output signal from the PID controller is PWM-converted and input to the BRK signal terminal 693 as the BRK signal 683. Then, the frequency F_{B} of the BRK signal 683 is set low in consideration of the delay time 884.

The frequency F_{B} and a period T_{B} of the BRK signal 683 subjected to the pulse width modulation are expressed by the following Expression 2.

F_{B}=1/T_{B}=1/(t₁₁+t₁₀) (Expression 2)

In Expression 2, t₁₁ represents a period during which the voltage level of the BRK signal is High, and t₁₀ represents a period during which the voltage level of the BRK signal is Low.

It is preferable that the frequency of the BRK signal is set so that the period T_{B} of the BRK signal is longer than the delay time 884. More specifically, it is preferable that the period T_{B} and the duty cycle of the BRK signal be set so that a High-level period t₁₁ of the BRK signal is longer than the delay time 884. In this case, the duty cycle of the BRK signal 683 is expressed by a ratio of the High-level period t₁₁ to the period T_{B} of the BRK signal 683, in other words, t₁₁/T_{B}×100(%). That is, the duty cycle becoming larger means that the High-level period t₁₁ of the BRK signal 683 becomes longer with reference to the period T_{B} of the BRK signal 683.

FIG. 7C illustrates the variations of the respective signals and the rotation speed 640 with time in the rotation speed control using the regenerative braking.

The frequency F_{D} of the PWM signal 682 is 25 kHz. In other words, the period T of the PWM signal 682 is 40 microseconds. The duty cycle is fixed to a predetermined value of 50%. The High-level period t₁ of the PWM signal 682 is 20 microseconds.

In this embodiment, a maximum frequency F_{Bmax} and a minimum frequency F_{Bmin} within a setting range of the frequency F_{B} of the BRK signal 683 are determined as follows.

In other words, the maximum frequency F_{Bmax} of the BRK signal 683 is set as a frequency with which the phase current 620 starts to flow in the reverse direction during the period T_{B} of the BRK signal 683 when assuming that the duty cycle of the BRK signal 683 is 100%.

Further, the minimum frequency F_{Bmin} of the BRK signal 683 is set as twice the maximum frequency of speed variations to be suppressed by the speed control.

However, if the frequency F_{B} of the BRK signal 683 is set low, sensitivity of the braking torque to a change in the duty cycle is likely to be high and the control period becomes shorter. Hence it is difficult to smoothly perform the rotation speed control. Therefore, trial and error are necessary to some extent in order to determine the frequency F_{B} of the BRK signal 683. In this embodiment, the frequency F_{B} of the BRK signal 683 is set to 2 kHz. The period T_{B} of the BRK signal 683 is 500 microseconds when the frequency F_{B} of the BRK signal 683 is 2 kHz. The period T_{B} of the BRK signal 683 is set so as to become longer than the period T of the PWM signal 682.

The frequency F_{D} of the PWM signal 682 is higher than the frequency F_{B} of the BRK signal.

The duty cycle of the BRK signal 683 is controlled by the controller (CPU 602 described later) so as to obtain an accelerating torque or a braking torque that brings the rotation speed of the intermediate transfer belt 101 to the target rotation speed.

In FIG. 7C, when the BRK signal 683 becomes ON state (voltage level of the BRK signal 683 becomes High), the phase current 620 flowing through the coil 400 is lowered. If a delay time 784 has elapsed since the BRK signal 683 becomes ON state (voltage level of the BRK signal 683 becomes High), the direction of the phase current 620 becomes reverse. When the direction of the phase current 620 becomes reverse, the counter-electromotive force is generated in the motor 152 to perform the regenerative braking. The regenerative braking lowers the rotation speed 640 of the motor 152 to the target rotation speed 630.

When the High-level period t₁₁ of the BRK signal 683 has elapsed, the BRK signal 683 becomes OFF state (voltage level of the BRK signal 683 becomes Low), the phase current 620 increases. The High-level period t₁₁ of the BRK signal 683 is set so as to become longer than the delay time 784. When the period T_{B} of the BRK signal 683 has elapsed, the BRK signal 683 becomes ON state, and the same operation is repeated. This can suppress rotation speed variations of the motor 152 caused by the disturbance. Therefore, it is possible to suppress color misregistration and banding.

That is, the motor driver (control device) 690 switches over the direction of the phase current (coil current) 620 flowing through the plurality of coils 400 of the motor 152 according to the BRK signal 683 having the period T_{B} longer than the period T of the PWM signal 682 for driving the motor 152. By switching over the direction of the current, the counter-electromotive force is generated, and a brake is put on the motor 152 by the regenerative braking, to thereby control the rotation speed of the intermediate transfer belt 101.

While the accelerating torque of the motor 152 is obtained based on the PWM signal 682, the controller (CPU 602 described later) maintains the voltage level of the BRK signal 683 at High until the braking torque of the motor 152 is obtained. With this operation, the direction of the phase current 620 flowing through each of the plurality of coils 400 of the motor 152 is switched over.

On the other hand, while the braking torque of the motor 152 is obtained based on the BRK signal 683, the controller keeps the BRK signal 683 in the OFF state until the accelerating torque of the motor 152 is obtained. With this operation, the direction of the phase current 620 flowing through each of the plurality of coils 400 of the motor 152 is switched over.

FIG. 8 is a schematic diagram of the torque generated by the rotation speed control using the regenerative braking.

For example, a braking torque 903 is generated by the BRK signal 683 during a period t₂₁, and after that, a constant accelerating torque 902 is generated by the PWM signal 682 having a fixed pulse width. As a result, a desired positive torque 901 can be output as an impulse.

On the other hand, a braking torque 905 is generated by the BRK signal 683 during a period t₃₁, and after that, a constant accelerating torque 906 is generated by the PWM signal 682 having a fixed pulse width. As a result, a desired negative torque 904 can be output as an impulse.

In this manner, by controlling the period t₂₁ or t₃₁ for generating the braking torque 903 or 905, the positive torque 901 or the negative torque 904 can be generated arbitrarily as the impulse. Therefore, the rotation speed control using the regenerative braking is extremely effective for a system having a large amount of disturbances that act in the acceleration direction of the motor.

In order to improve efficiency of transferring the toner image from the photosensitive drum 100 to the intermediate transfer belt 101, the image forming apparatus 1 is provided with a rotation speed difference so that the rotation speed of the intermediate transfer belt 101 becomes lower than the rotation speed of the photosensitive drum 100.

For that reason, the rotation speed of the intermediate transfer belt 101 is accelerated in the contact involved in the transfer of the toner image from the photosensitive drum 100 to the intermediate transfer belt 101. Therefore, it is preferable that the braking torque is generated in the motor 152 configured to drive the intermediate transfer belt 101 in order to decelerate the intermediate transfer belt 101.

The rotation speed control using the regenerative braking has a wide control range of the braking torque, and hence, based on the relationship of the rotation speed difference between the photosensitive drum 100 and the intermediate transfer belt 101, the speed control is performed for the one to be accelerated, in other words, the intermediate transfer belt 101, as a control subject. This is because, through the use of the regenerative braking, it is possible to apply a negative-direction torque for decelerating the one to be accelerated (to be rotated). In this manner, by performing the speed control for the one to be rotated, it is possible to effectively suppress the speed variations and prevent the color misregistration and the banding.

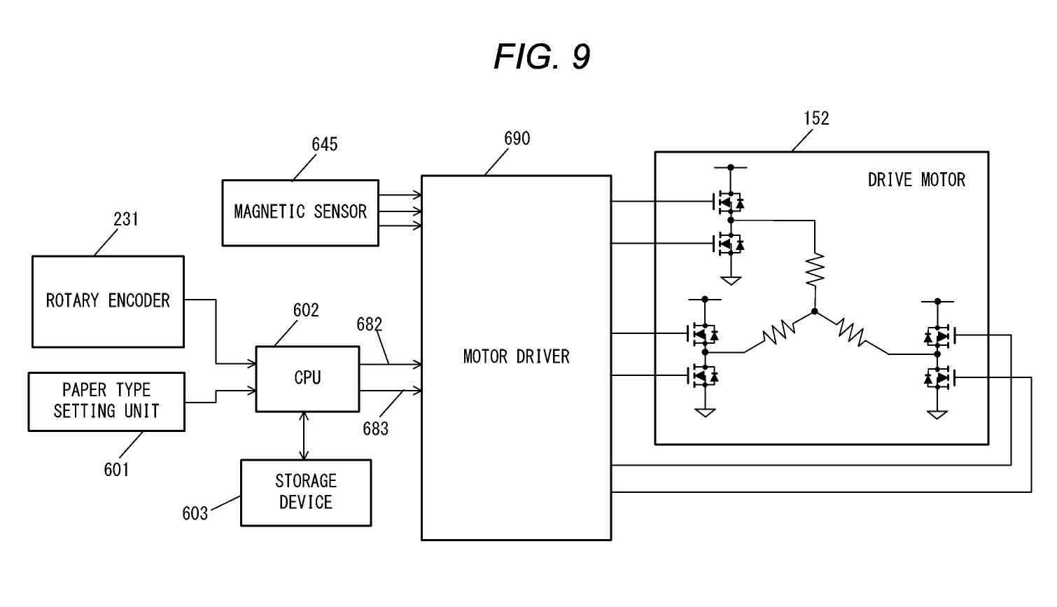

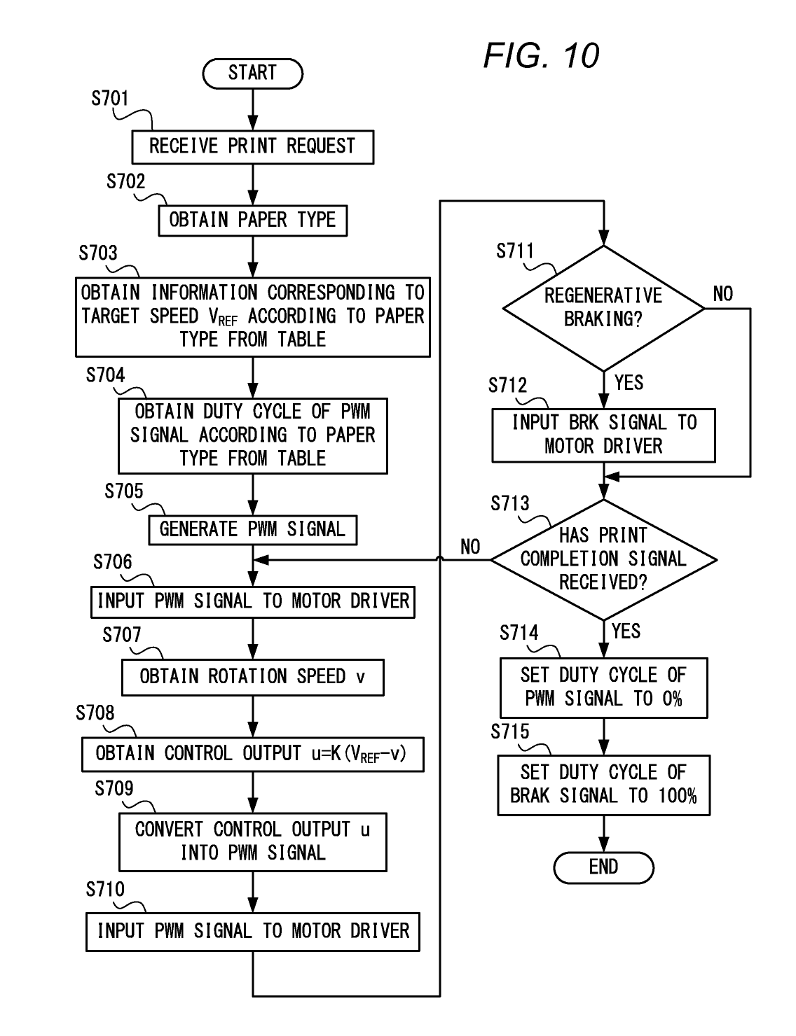

FIG. 9 is a block diagram of a rotation speed control system applied to the image forming apparatus 1. Further, FIG. 10 is a flowchart of the rotation speed control according to this embodiment.

First, a control unit (hereinafter referred to as “CPU”) 602 receives a print request from a user (S701). Further, when receiving the print request, the CPU 602 acquires paper type information set by the user through a paper type setting unit 601 (S702).

Then, the CPU 602 acquires information (frequency F_{B} of the BRK signal) corresponding to a target rotation speed V_{REF} of the motor 152 according to the paper type information set by the paper type setting unit 601, from the table stored in a storage device 603 (S703).

Further, the CPU 602 acquires the duty cycle of the PWM signal 682 according to the paper type information set by the paper type setting unit 601 from the table stored in the storage device 603 (S704).

Subsequently, the CPU 602 generates the PWM signal 682 having the acquired duty cycle (S705).

Then, the generated PWM signal 682 is input to the motor driver 690 (S706).

After the generated PWM signal 682 is input to the motor driver 690, the CPU 602 acquires an actual rotation speed “v” of the motor 152 from the rotary encoder 231 (S707), and obtains a control output “u” (S708). The control output “u” is expressed by the following Expression 3.

u=K(V_{REF}−v) (Expression 3)

In Expression 3, K is a constant. The control output “u” can be obtained by multiplying the deviation (V_{REF}−v) between the target rotation speed V_{REF} and the actual rotation speed “v” of the motor 152 by the constant K.

Then, the CPU 602 converts the control output “u” into the PWM signal 682 (S709), and inputs the converted PWM signal 682 to the motor driver 690 (S710). The control output “u” is converted into the PWM signal 682 so that a maximum value and a minimum value which can be assumed by the control output “u” are a duty cycle of 100% and a duty cycle of 0%, respectively.

Note that, in this control, the frequency of the PWM signal 682 is set to 25 kHz outside the audible range.

Further, the speed control is performed by using the braking torque, and hence the duty cycle of the PWM signal 682 is set larger than the duty cycle with which the rotation speed reaches the target rotation speed V_{REF in an} open loop control. The value of the duty cycle indicates the same behavior as a proportional element of the PID controller, and is therefore determined by performing trial and error at a time of designing the PID controller, with the result that the duty cycle used in this control is determined as 72%.

In addition, the frequency of the BRK signal 683 is determined as 700 Hz so as to fall within a range between the maximum frequency and the minimum frequency described above.

The CPU 602 determines whether or not to put on the regenerative braking according to the rotational speed “v” acquired from the rotary encoder 231 (S711). When the regenerative braking is to be put on the motor 152 in order to decelerate the rotation speed of the motor 152 (YES in S711), the CPU 602 inputs the BRK signal 683 having a voltage level of High to the BRK signal terminal 693 (FIG. 2) of the motor driver 690 (S712).

After that, the CPU 602 determines whether or not a print completion signal has been received (S713).

On the other hand, when the regenerative braking is not to be put on (NO in S711), the procedure proceeds to Step 5713, and the CPU 602 determines whether or not the print completion signal has been received.

When the print completion signal has not been received (NO in S713), the procedure returns to Step 5706.

When the print completion signal has been received (YES in S713), the regenerative braking is put on the motor 152 to stop the motor 152 by setting the duty cycle of the PWM signal 682 to 0% (S714) and setting the duty cycle of the BRK signal 683 to 100% (S715).

In this embodiment, the speed control using the regenerative braking is described, but the plugging or the reverse current braking may be used instead of the regenerative braking.

In the case of a speed control using the reverse current braking, when a braking is put on a motor, it suffices that the current is caused to flow through a phase corresponding to a direction reverse to a before-brake direction. That is, as illustrated in FIG. 7D, the reverse current braking can be realized by switching over the voltage level of the rotational direction switchover signal 681 and reversing the direction of the accelerating torque.

When the reverse current braking is put on a motor, in addition to the counter-electromotive voltage due to the electromagnetic induction, a current necessary for reverse rotation is supplied from a power supply voltage, and hence a current larger than a current flowing when the regenerative braking is put on the motor can flow. That is, a braking torque generated when the reverse current braking is put on is larger than a braking torque generated when the regenerative braking is put on. Hence the reverse current braking can effect a rapid deceleration.

As a result, a delay time 785 required until the torque acts as the braking torque can be made shorter than the delay time 784 (FIG. 7C) at the time of the regenerative braking, and hence it is possible to improve the control bandwidth. This can suppress the rotation speed variations of the motor 152 caused by the disturbance. Therefore, it is possible to suppress the color misregistration and the banding.

In the regenerative braking and the reverse current braking described above, the duty cycle of the PWM signal (BRK signal subjected to the pulse width modulation) for braking is changed.

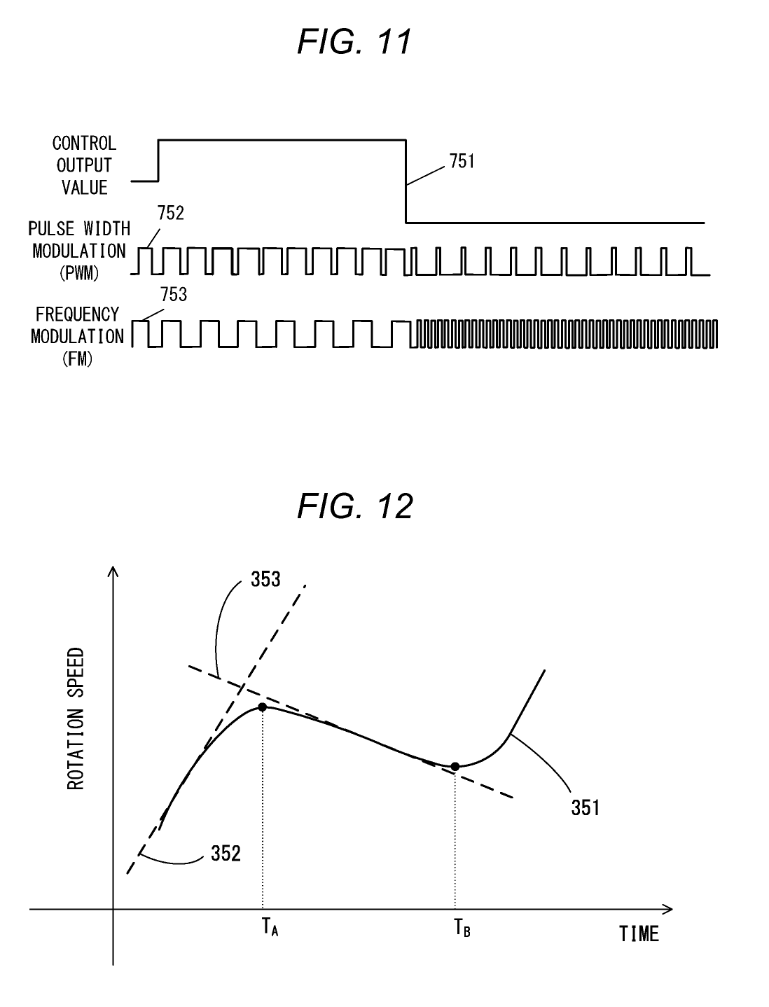

However, braking control can be realized also by using a frequency modulation signal (hereinafter referred to as “FM signal”) 753 instead of a pulse width modulation signal 752 for a control output value 751 for braking as illustrated in FIG. 11. However, when the control output value 751 is subjected to frequency modulation, as a voltage value becomes larger, the frequency is set lower.

Such an FM signal for braking can be used as the BRK signal 683 as illustrated in FIG. 7E.

The minimum frequency of the FM signal is set so that a difference between a carrier wave frequency and a maximum frequency deviation becomes equal to or larger than the minimum frequency of the BRK signal 683.

Further, the maximum frequency of the FM signal is set so that a difference between the maximum frequency deviation and the carrier wave frequency becomes equal to or smaller than the maximum frequency of the BRK signal 683.

The frequency of the FM signal is finally determined so that control performance conforms to design specifications while the speed control is performed in actuality.

This embodiment is described by taking a three-phase brushless DC motor as an example, but the present invention can also be applied to a brushless DC motor having the number of phases other than three phases.

Further, the present invention is not limited to the type or structure of the motor, and can be applied to any motor that can generate the braking torque by changing the direction of the phase current.

According to this embodiment, an operation period of an electric brake is set longer than a delay time of the electric brake, thereby enabling the braking torque to effectively work.

Further, according to this embodiment, the period during which the electric brake works is controlled so that the disturbance which acts in the acceleration direction of the motor can be effectively suppressed.

According to this embodiment, the direction of the coil current is switched over according to a brake signal having a period larger than a period of a drive signal for driving the motor, to thereby put a brake on the motor, which can control the rotation speed of the image bearing member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-264738, filed Dec. 2, 2011, which is hereby incorporated by reference herein in its entirety.

What is claimed is:

1. An image forming apparatus, comprising:
a motor having a winding in which a plurality of coils are connected to one another, the motor configured to rotate an image bearing member by a switchover of a direction of a current flowing through each of the plurality of coils; and
a control device configured to switch over the direction of the current flowing through each of the plurality of coils of the motor in order to put a brake on the motor separately from the switchover of the direction of the current flowing through each of the plurality of coils in order to drive the motor,
wherein the control device switches over the direction of the current flowing through each of the plurality of coils of the motor, according to a brake signal having a period larger than a period of a drive signal for driving the motor, so as to put a brake on the motor in order to control a rotation speed of the image bearing member.

2. An image forming apparatus according to claim 1, wherein when an accelerating torque of the motor is obtained according to the drive signal, the control device maintains the brake signal until a braking torque of the motor is obtained, to switch over the direction of the current flowing through each of the plurality of coils of the motor.

3. An image forming apparatus according to claim 1, wherein when a braking torque of the motor is obtained according to the brake signal, the control device keeps the brake signal in an OFF state until an accelerating torque of the motor is obtained, to switch over the direction of the current flowing through each of the plurality of coils of the motor.

4. An image forming apparatus according to claim 1, wherein the drive signal and the brake signal each comprises a pulse width modulation signal;
a frequency of the drive signal is larger than a frequency of the brake signal;
a duty cycle of the drive signal is fixed to a predetermined value; and
a duty cycle of the brake signal is controlled by the control device so that an accelerating torque or a braking torque which brings the rotation speed of the image bearing member into a target rotation speed is obtained.

5. An image forming apparatus according to claim 4, further comprising:
a paper type setting unit configured to set paper type information; and
a storage device configured to store information corresponding to the target rotation speed according to the paper type information,
wherein the control device obtains from the storage device the information corresponding to the target rotation speed according to the paper type information set by the paper type setting unit, and generates the drive signal and the brake signal based on the information obtained.

6. An image forming apparatus according to claim 1, wherein the brake signal comprises a frequency modulation signal.

7. An image forming apparatus according to claim 1, wherein the image bearing member comprises a photosensitive drum or an intermediate transfer belt.
